(19) United States
(12) Patent Application Publication
(10) Pub. No.: US 2004/0148107 A1
(43) Pub. Date: Jul. 29, 2004

(54) Method and system for evaluating properties of a beverage

(75) Inventors: Jeffrey J. Piotrowski, Rodkledge, FL (US); Douglas S. Burns, Melbourne, FL (US); Thomas C. Buist, Melbourne, FL (US)

Correspondence Address: NIXON PEABODY, LLP, 401 9TH STREET, NW, SUITE 900, WASINGTON, DC, 20004-2128, US

(73) Assignee: ENSCO, Inc., Springfield, VA

(21) Appl. No.: 10/717,899

(22) Filed: Nov. 21, 2003

Related U.S. Application Data
(60) Provisional application No. 60/428,242, filed on Nov. 22, 2002.

(51) Int. Cl. G06F 19/00

(52) U.S. Cl. 702/31

(57) ABSTRACT

A system, method, and computer program product for aiding a consumer in choosing a beverage based upon personal preferences of the consumer, including obtaining spectral information of an inventory of beverages, obtaining spectral information of a sample of a beverage, and comparing the spectral information of the sample with that of the inventory to determine a beverage from the inventory that is similar to the sample. The spectral information for at least one of the inventory and the sample is obtained in a non-destructive manner.

### CROSS REFERENCE TO RELATED DOCUMENTS

The present invention claims benefit of priority to commonly assigned, co-pending, U.S. Provisional Patent Application Serial No. 60/428,242 of Piotrowski et al., entitled “METHOD OF EVALUATING THE PROPERTIES OF WINE,” filed Nov. 22, 2002, the entire disclosure of which is hereby incorporated by reference herein.

### BACKGROUND OF THE INVENTION

1. Field of the Invention

The present invention generally relates to methods and systems for determining properties of items, and more particularly to a method and system for aiding a consumer of a beverage, such as wine, beer, and the like, in choosing a new beverage based upon personal preferences.

2. Discussion of the Background

Wine making has existed for thousands of years. The modern system of evaluating wines is based upon the subjective opinion of wine experts. While this system is useful in some aspects, it is not without flaws. If a wine consumer desires to taste various wines and has the time and financial means to do so, the wine consumer can develop a set of wines that they enjoy. Alternatively, the wine consumer will also be able to identify features that they do or do not like in a wine.

However, the above-noted approach is not feasible for a majority of wine consumers. For example, many wine consumers may have difficulty when selecting a bottle of wine due to the wide range in varieties of wines. Additionally, individuals may also have trouble recalling which bottles they have previously tasted and what they liked about a particular wine. Because the conventional rating system is based upon personal tastes of a third party, there also is the possibility of personal biases dictating the entire scale. Wine is produced worldwide and different regions that are affected by different conditions, therefore, it becomes even more difficult to relate wines purely on taste.

There are many resources currently available to wine consumers when selecting wines. For example, wine consumers can choose a wine using publications, such as books, magazines, and the like, using web sites, using recommendations from friends or family, using personal experiences, and the like. However, most of such available resources involve some effort on the part of the consumer to research what is available and how their own preferences match those of the so-called experts. Also, such information must be written or recalled when shopping, and, depending upon the store, the selections that were researched may not be available. Relying on acquaintances and personal experience can also become a hit-or-miss situation. Finally, the cost of wine can make it prohibitively expensive for a consumer to find new enjoyable wines.

Techniques have been developed in an attempt to characterize wine, for example, based on light scattering properties of wine, as described in U.S. Pat. No. 4,490,042. Such techniques typically involve opening the bottle of wine, removing an aliquot or sample of the wine for scanning and then comparing the scan data to a catalog of data representing personal standards or preferences. However, such as technique typically involves the destruction of the sample (e.g., once the bottle is opened the bottle is no longer preserved) and thus is a costly way to develop a catalog of wine preferences for personal use. In addition, U.S. Pat. No. 4,490,042 also is generally directed to a measurement apparatus for scanning wine samples, but, however, fails to disclose allowing a wine consumer to select wines from a wine list that correspond to personal preferences of the consumer.

### SUMMARY OF THE INVENTION

Therefore, there is a need for a method and system for aiding a wine consumer in choosing a new wine based upon personal preferences and in a non-destructive manner. The above and other needs are addressed by the exemplary embodiments of the present invention, which provide a system and method for aiding a wine consumer in choosing a new wine based upon personal preferences, including obtaining spectral information for a wine inventory and for a sample of wine preferred by a consumer and matching the spectra of the wine inventory with the sample to determine wines from the inventory that may be preferred by the consumer. Advantageously, the system and method can obtain the spectra of the wine inventory and the sample in a non-destructive manner and allow a wine consumer to select wines from the wine inventory that correspond to personal preferences of the consumer.

Accordingly, in aspects of the present invention, a system, method, and computer program product for aiding a consumer in choosing a beverage based upon personal preferences of the consumer are provided. The system, method, and computer program product include obtaining spectral information of an inventory of beverages, obtaining spectral information of a sample of a beverage, and comparing the spectral information of the sample with that of the inventory to determine a beverage from the inventory that is similar to the sample. The spectral information for at least one of the inventory and the sample is obtained in a non-destructive manner.

Still other aspects, features, and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is a flowchart for illustrating an exemplary process for determining similarities between a beverage inventory and a beverage sample;

FIG. 2 is a diagram of an exemplary system for extracting spectral information from a beverage sample;

FIG. 3 is a diagram of an exemplary system for aiding a beverage consumer in choosing a new beverage based upon personal preferences;

FIG. 4 illustrates results of an exemplary algorithm for associating three types of wine beverages with respect to preferences of three individuals;

FIG. 5 illustrates results of an exemplary algorithm for identifying a specific preference of wine beverage samples and non-preferred outliers; and

FIG. 6 is an exemplary computer system, which may be programmed to perform one or more of the processes of the described exemplary embodiments.

### DETAILED DESCRIPTION OF THE PREFERRED EMBODIMENTS

The present invention includes the recognition that the wine industry has existed for many years, and has seen many developments and improvements in both the production and taste of wine. The present invention, however, further recognizes that there are still several aspects of the wine industry that require examination and improvement in order to make wine more available to the general public. Generally, the exemplary embodiments of the present invention provide an improved method and system for aiding an average consumer of a beverage, such as wine, beer, soda, and the like, in evaluating a bottle of the beverage and then assisting the consumer in discovering similar beverage products based upon personal tastes of the consumer. Essentially, the average consumer has a difficult time exploring their own tastes because they lack the time or financial means in which to purchase or sample many various types of beverages, such as wines, beer, soda, and the like. In an exemplary embodiment, the consumer need not be told what he or she enjoys about a particular beverage, such as a bottle of wine, beer, soda, and the like, but rather the exemplary embodiments provide a percentage based upon a similarity (e.g., a percent similarity) between one bottle of the beverage to another.

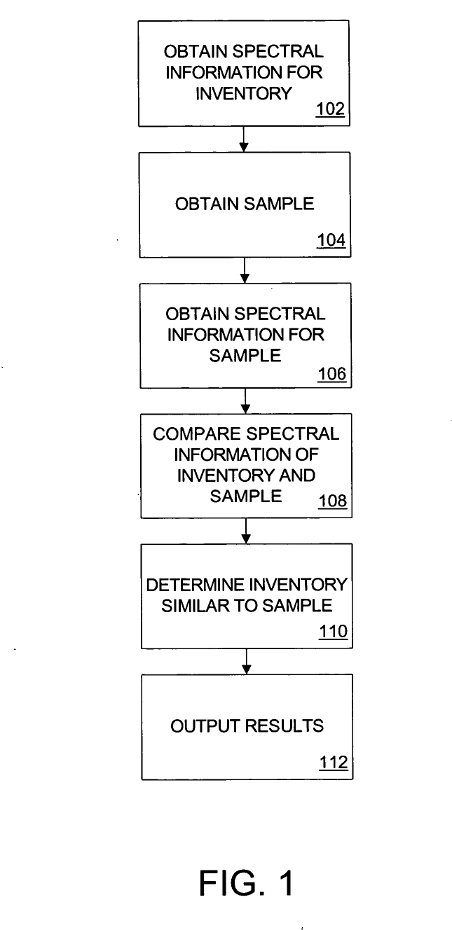

Referring now to the drawings, wherein like reference numerals designate identical or corresponding parts throughout the several views, and more particularly to FIG. 1 thereof, there is illustrated a flowchart of an exemplary process for determining similarities between a beverage inventory and a beverage sample, such as an inventory of wines, beers, sodas, and the like.

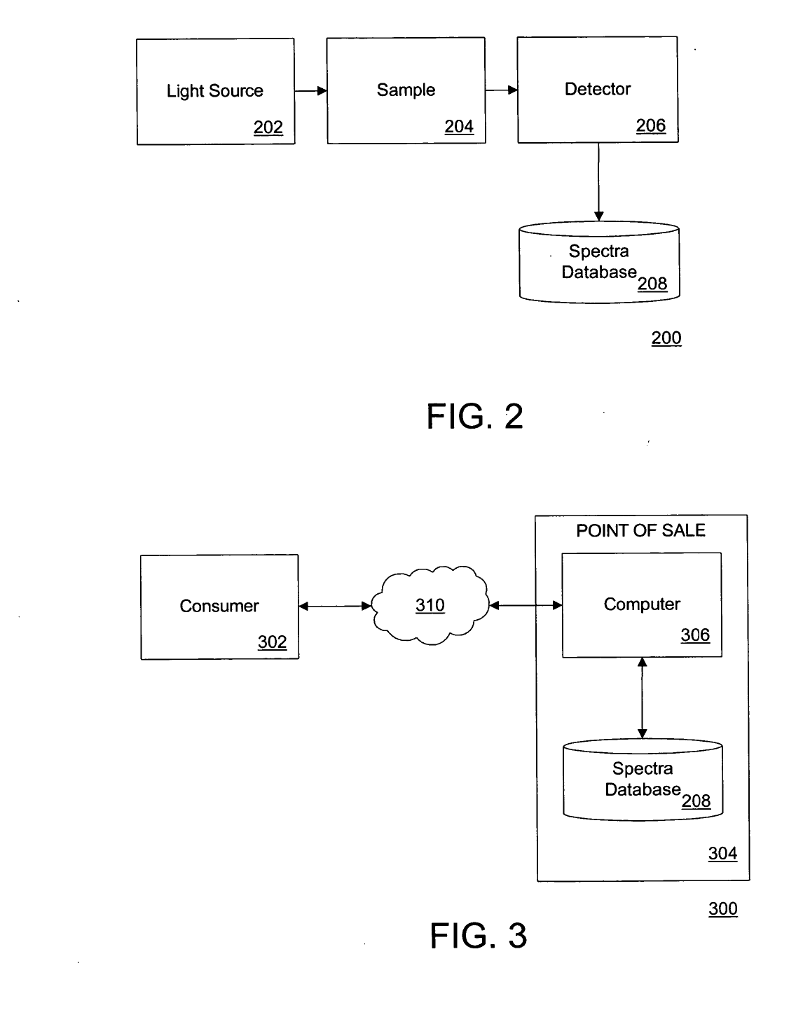

In FIG. 1, at step 102, any suitable technique for extracting spectral information, for example, as further described with respect to FIG. 2, can be employed to extract spectral information from an inventory of beverages, such as bottles of wines, and the like. At step 104, a sample of a given beverage is obtained, for example, a bottle of wine, and the like, preferred by a wine consumer. At step 106, the spectral information for the sample is obtained. At step 108, a comparison is made between the spectral information of the sample and that of the inventory to determine a similarity, for example, a percentage similarity, and the like, therebetween. At step 110, beverages from the inventory that are similar to the sample are determined, for example, based on a threshold for the percentage similarity, and the like, determined at step 108. At step 112, the results of the determination step 110 can be output, for example, displayed to the beverage consumer, and the like, to aid the consumer in choosing beverages from the inventory that are similar to a preferred beverage of the consumer, and the like.

In an exemplary embodiment, the process of FIG. 1 can be employed to classify a given sample into a category of the inventory. For example, the exemplary process of FIG. 1 can be employed to classify a given bottle of a beverage, such as a bottle of wine, beer, and the like, into a category, such cabernet sauvignon, chardonnay, merlot, white wine, red wine, pale ale, pilsner, bock, wheat beer, amber ale, light beer, dark beer, and the like.

FIG. 2 is a diagram of an exemplary system 200 for extracting spectral information from a beverage sample and that can be employed in the exemplary process of FIG. 1 for determining similarities between a beverage inventory and a beverage sample. In FIG. 2, the exemplary system 200 can include a light source 202, such a white light source from a tungsten lamp, and the like, a sample 204, such as a bottle of a beverage or sample taken from a bottle of a beverage, a detector 206 for detecting light spectra reflected, transmitted, and/or absorbed from the sample 204, and a database 208 for storing the detected light spectra, such as a database for storing wine spectra, beer spectra, and the like. In an exemplary embodiment, the exemplary system 200 can employ, for example, near infrared (NIR), mid infrared (MIR) spectroscopy, and the like, to extract the spectral information, and the like.

In an exemplary embodiment, the spectral information can be obtained in a non-destructive manner, for example, through the bottles of the inventory and the bottle of the sample, taking into account factors, such as bottle color, and the like, during the spectral analysis. In a further exemplary embodiment, however, the spectral analysis can be performed in a destructive manner, for example, based on samples taken from open bottles of the inventory and the sample, in which case the noted factors need not be considered.

FIG. 3 is a diagram of an exemplary system 300 for aiding a beverage consumer in choosing a new beverage based upon personal preferences. In FIG. 3, the exemplary system 300 can include a consumer or consumer device 302, and a point-of-sale or point-of-sale device 304, such as an online or offline beverage retailer, and the like, and can employ the exemplary system 200 for extracting spectral information of FIG. 2. The consumer 302 and the point-of-sale 304 can communicate with each other over a communications network 310, such as the Internet, a local area network (LAN) of the point-of-sale 304, and the like, coupled to a kiosk, consumer 302 device, and the like. The point-of-sale 304 can include a computer 306 coupled to the database 208. The exemplary system 300 can employ statistical regressions to cluster different samples of beverages according to similarities in the beverages, to cluster the spectra of the beverages based on the samples, to provide for input of user preferences via a graphical user interface (GUI) into the database 208 to help identify trends in personal tastes, and can be implemented so as to provide a user oriented and friendly system.

In the exemplary embodiments of FIGS. 1-3, preferences of an individual can be determined using any suitable algorithm that can quantify a certain trait, for example, as determined by a percent similarity at a specific wavelength, by a set of characteristic wavelengths, and the like. A dataset can be employed to determine the taste of an individual over a variety of beverage types, such wine types, beer types, and the like.

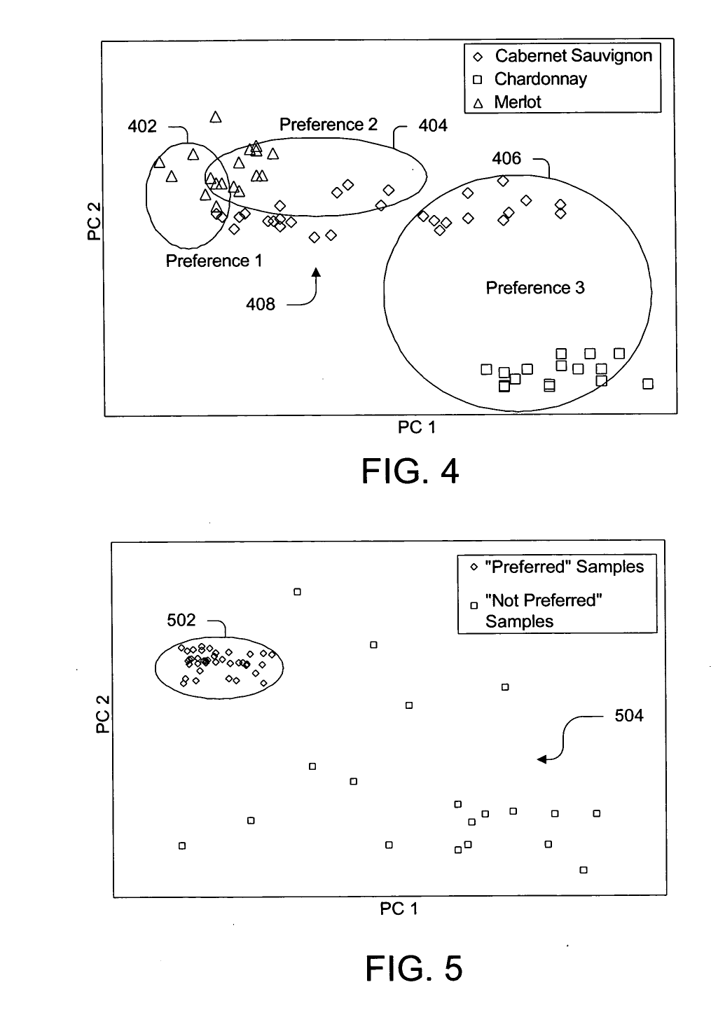

FIG. 4 illustrates results of an exemplary algorithm for associating, for example, three types of wine beverages with respect to preferences of three individuals. In FIG. 4, for example, a representative correlation depicts the preferences 402-406 of three individuals associated with three different types of wine. Advantageously, a specific trait that is responsible for the preference need not be determined, but rather a quantifiable trait or set of traits that separates the preferred samples 402-406 from the not-preferred samples 408 can be employed. The exemplary embodiments of FIGS. 1-4 can employ regression models, and the like, for statistical analysis, wherein the accuracy of such analysis can depend on the accuracy of the procedures used to build such models.

FIG. 5 illustrates results of an exemplary algorithm for identifying a specific preference 502 of beverage samples and non-preferred outliers 504. In FIG. 5, for example, once a preference is identified, the samples that are found within that specified preference are further analyzed to locate specific wavelengths that can be used to identify a correlation with other preferred samples 502. In an exemplary embodiment, the specific variety of a beverage, such as a wine, beer, and the like, need not be important to the algorithm. Accordingly, each sample can be analyzed on the basis that there is a trait or set of traits that can be found in a quantifiable amount. Such an amount, for example, can be quantified by the intensity of absorbance or reflectance of light at a wavelength or groups of wavelengths. Once one or more traits are identified, statistical analysis can be performed to isolate the preferred samples 502 in the dataset, as shown in FIG. 5.

The exemplary embodiments of FIGS. 1-5 incorporate the database 208 of spectral information, such as spectral peaks, and the like, into a user-friendly system 300 that can be widely applied. The exemplary embodiments can employ a dynamic algorithm to create in the database 208 preferences of different individuals. The exemplary embodiments of FIGS. 1-5 can perform the steps of establishing the database 208, for example, including the spectra of at least fifty different bottles of beverages, such as bottles of wines, bottles of beers, and the like. The exemplary embodiments of FIGS. 1-5 can employ statistical regressions to cluster different samples of beverages, according to similarities in the beverages, and to cluster the spectra of the beverages based on the samples, can provide for input of user preferences into the database 208 to help identify trends in personal tastes, can be implemented in a user oriented and friendly system 300, and the like.

The exemplary embodiments of FIGS. 1-5 can be employed for evaluation of samples, for example, using NIR spectroscopy, and the like, and can include making a determination concerning what products are in a certain group of beverages, for example, what wines are within the groups of chardonnay, merlot, and the like, what beers are in the groups of pale ale, pilsner, and the like. An examination then can be performed on each product in a group, and a calculated percent similarity can be assigned between the products in the groups. To obtain a measure of the precision for such techniques, for example, in evaluating and classifying samples of merlot, a relatively good training set of data need be employed, as the training set typically determines the accuracy as far as what constitutes a relatively good or bad sample of a given group.

The exemplary embodiments of FIGS. 1-5 for the evaluation of beverage samples, for example, using NIR spectroscopy, and the like, can include a quantifiable form of evaluation, wherein a group of samples is examined, for example, for alcohol content, and the like. Such a quantifying procedure can include fitting an equation to a set of data points based upon a multiple linear regression (MLR) algorithm, a partial least squares (PLS) algorithm, a genetic algorithm (GA), and the like. In an exemplary embodiment, a principle component analysis (PCA) can be employed, for example, to identify one or more of the wavelengths of the traits that can be quantified, and the like.

The exemplary embodiments of FIGS. 1-5 can include a software program that enables a consumer to choose from the database 208 a particular beverage, such as a wine or beer, from a list of available beverages that the consumer has enjoyed in the past or can be used to allow the consumer to avoid beverages that the consumer has not enjoyed in the past. Advantageously, the consumer need not have a predetermined set of wine preferences, since such information can be generated when accessing the database 208.

In the exemplary embodiments of FIGS. 1-5, a list of representative spectra of beverages, such as wines, beers, and the like, that have been scanned in a non-destructive manner can be stored in the database 208. In an exemplary embodiment, the evaluation of the beverages can be made by providing and detecting visible, near infrared, and/or infrared wavelengths, for example, that are in the range of 400-700 nm (e.g., visible), 700-2500 nm (e.g., NIR), 2500-15,000 nm (e.g., MIR), and the like, using an appropriate lamp and detector, such as the light source 202 and the detector 206.

In an exemplary embodiment, the lamp can be configured to provide, for example, white light having components at various wavelengths, which can include visible, near infrared, and/or infrared wavelengths. Such spectral data can be obtained by sensing scattered light from the beverage and the bottle or from the beverage only, wherein the scattered light carries information about the beverage. The obtained spectra can then be stored in the database 208.

The exemplary embodiments of FIGS. 1-5 can include a software program, including statistical algorithms, and the like, that can be used compare the spectra of beverages chosen by the consumer 302 with the spectra in the database 208. These spectra then can be evaluated, for example, to identify one or more common features or traits that correlate to similar characteristics in other beverages that the consumer 302 prefers or dislikes. The exemplary software then can be used to display via the GUI a list of beverages that have been identified as having similar spectral characteristics as those preferred by the consumer 302. The consumer 302 can then select beverages from this list via the GUI.

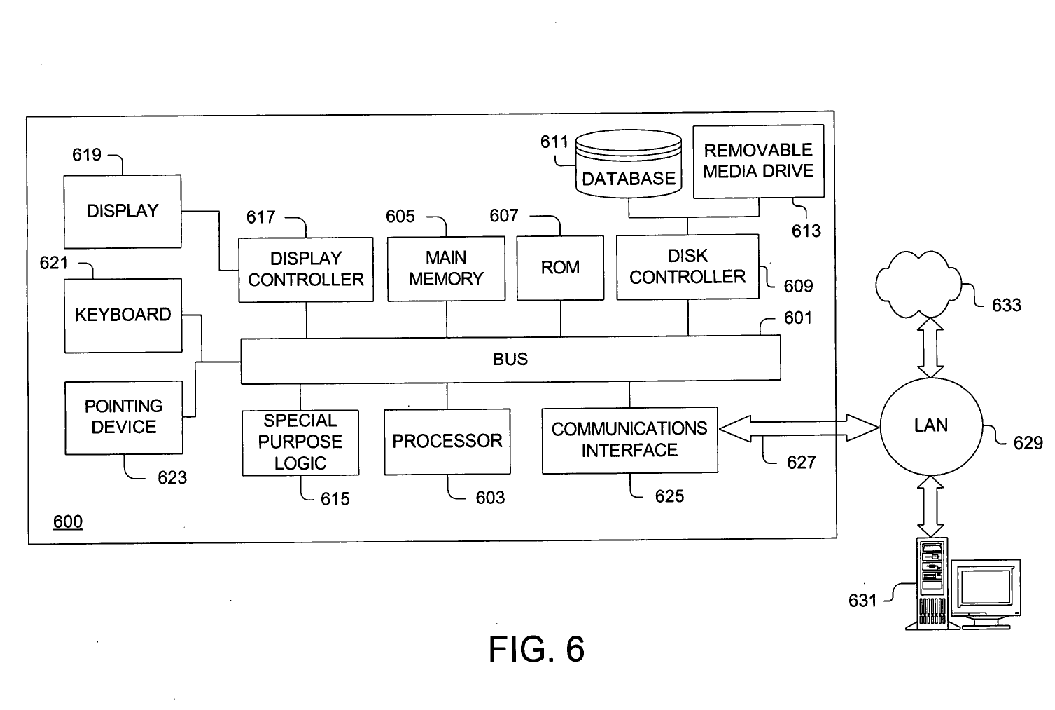

The exemplary software can be housed in a computer, such as the computer 306, for example, a personal computer 600 described with respect to FIG. 6, and the like, located at an online or offline establishment, such as a wine retailer, beer retailer, and the like, and available for use by the consumer 302 before, during or after online or offline shopping. In an exemplary embodiment, additional information which can aid the consumer 302 in making a decision can be provided via the GUI, such as sale information, whether the beverage is in stock, and the like. In a further exemplary embodiment, the exemplary software can be employed with a personal digital assistant (PDA), handheld device, cellular phone, and the like.

In addition, search criteria can be entered by the consumer 302 via the GUI and can be used by the exemplary software, for example, to narrow a displayed inventory, such as displayed wine list, beer list, and the like, corresponding to preferences of the consumer 302. Such criteria can include price information, beverage type, such pinot noir, merlot, pale ale, pilsner, and the like, whether a preferred wine is a red or white wine, whether a preferred beer is a pilsner or a dark beer, and the like.

Thus, the exemplary embodiments of FIGS. 1-5 allow predicting of personal beverage preferences, such wine preferences, beer preferences, and the like, advantageously, allowing for a consumer to predict a priori one or more preferred beverages. The exemplary embodiments provide a rapid, non-destructive, method and system for creating a library of spectra for wines, beers, and the like. For example, the exemplary embodiments of FIGS. 1-5 can employ NIR spectroscopy to scan wines or beers in their existing bottles to generate such spectra. The exemplary embodiments of FIGS. 1-5 also can be used to scan aliquots of wine or beer removed from the bottle to generate such spectra.

The exemplary embodiments of FIGS. 1-5 can employ statistical algorithms to match a selected beverage spectra, such as wine spectra, beer spectra, for example, chosen by a consumer, with beverage spectra having similar spectral characteristics in the database 208. The exemplary embodiments of FIGS. 1-5, thus, can include software that enables a consumer to easily select a beverage, such as wine, beer, and the like, that the consumer has enjoyed in the past. For example, using the GUI of exemplary embodiments of FIGS. 1-5, searching and viewing of the results of the search in the database 208 for a beverage, such as a wine, beer, and the like, having similar spectral characteristics as that of a selected beverage can be performed. The exemplary embodiments of FIGS. 1-5 can include software for practicing the exemplary methods for predicting personal beverage preferences on devices, such PCs, PDAs, and the like.

Advantageously, the exemplary embodiments of FIGS. 1-5 allow a consumer to quickly identify new beverages, such as wines, beers, and the like, that the consumer might enjoy or beverages to avoid that are poor candidates, based upon personal preferences of the consumer. For example, the consumer, advantageously, need not research wine prior to shopping for a particular wine. In addition, the exemplary embodiments of FIGS. 1-5 can be employed for choosing wines for a third party. For example, as long as the wine preferences of the third party are known, the exemplary embodiments of FIGS. 1-5 can be employed to select other candidate wines that the third party might enjoy.

In addition, the exemplary embodiments of FIGS. 1-5 can have a major effect on a beverage industry, such the wine industry, beer industry, and the like. The exemplary embodiments of FIGS. 1-5 can be implemented on a large-scale, advantageously, re-establishing the current methods used to evaluate a beverage, such as wine, beer, and the like. For example, the exemplary embodiments of FIGS. 1-5 can be used to replace existing methods of rating a beverage, such as wine, beer, and the like.

By contrast, typical rating procedures are based upon the decision of individual experts, such as wine experts, beer experts, and the like, and their subjective tastes. The exemplary embodiments of FIGS. 1-5, on the other hand, advantageously, eliminate such subjectivity by analytically isolating a trait or traits that are favored by an individual. Thus, advantageously, the exemplary embodiments of FIGS. 1-5 provide the capability to evaluate a beverage, such wine, beer, and the like, in a manner more personal to a consumer, rather than relying on personal preferences of a third party, such as a wine expert, beer expert, and the like.

The above-described devices and subsystems of the exemplary embodiments of FIGS. 1-5 can include, for example, any suitable servers, workstations, Personal Computers (PCs), laptop computers, Personal Digital Assistants (PDAs), Internet appliances, handheld devices, cellular telephones, wireless devices, other devices, etc., capable of performing the processes of the exemplary embodiments. The devices and subsystems can communicate with each other using any suitable protocol and can be implemented, for example, using the computer system 600 of FIG. 6. The devices and subsystems of the exemplary embodiments of FIGS. 1-5 can communicate with each other over a communications network, such as the communications network 310, such as the Internet, an intranet, a local area network (LAN), and the like.

One or more interface mechanisms can be used in the exemplary embodiments of FIGS. 1-5 including, for example, Internet access, telecommunications in any suitable form, for example, voice, modem, wireless communications media, and the like. Accordingly, the communications network 310 employed in the exemplary embodiments of FIGS. 1-5 can include, for example, one or more wired or wireless communications networks, cellular communications networks, G3 communications networks, Public Switched Telephone Network (PSTNs), Packet Data Networks (PDNs), the Internet, intranets, and/or combination thereof, and the like.

It is to be understood that the embodiments of FIGS. 1-5 are for exemplary purposes, as many variations of the specific hardware and software used to implement the described embodiments are possible, as can be appreciated by those skilled in the relevant art(s). For example, the functionality of one or more of the devices and the subsystems of the exemplary embodiments of FIGS. 1-5 can be implemented via one or more programmed computer systems or devices.

To implement such variations as well as other variations, a single computer system (e.g., the computer system 600 of FIG. 6) can be programmed to perform the special purpose functions of one or more of the devices and subsystems of the exemplary embodiments of FIGS. 1-5. On the other hand, two or more programmed computer systems or devices can be substituted for any one of the devices and subsystems of the exemplary embodiments of FIGS. 1-5. Accordingly, principles and advantages of distributed processing, such as redundancy, replication, etc., also can be implemented, as desired, for example, to increase the robustness and performance of the exemplary embodiments of FIGS. 1-5.

The exemplary embodiments of FIGS. 1-5 can store information relating to various exemplary processes described herein. This information can be stored in one or more memories, such as a hard disk, optical disk, magneto-optical disk, RAM, and the like, of the devices of the exemplary embodiments of FIGS. 1-5. One or more databases of the devices and subsystems of the exemplary embodiments of FIGS. 1-5, such as the spectra database 208, and the like, can store the information used to implement the exemplary embodiments of the present invention. The databases can be organized using data structures (e.g., records, tables, arrays, fields, graphs, trees, and/or lists) included in one or more memories, such as the memories listed above or any suitable storage devices, such as the storage devices listed below in the discussion of FIG. 6, and the like.

The exemplary embodiments of FIGS. 1-5 can include appropriate data structures for storing data collected and/or generated in one or more databases thereof, such as the spectra database 208, and the like. Such data structures, accordingly, can include fields for storing such collected and/or generated data. In a database management system, data can be stored in one or more data containers, each container including records, and the data within each record can be organized into one or more fields. In relational database systems, the data containers can be referred to as tables, the records can be referred to as rows, and the fields can be referred to as columns. In object-oriented databases, the data containers can be referred to as object classes, the records can be referred to as objects, and the fields can be referred to as attributes. Other database architectures can be employed and use other terminology. Systems that implement the exemplary embodiments of the present invention are not limited to any particular type of data container or database architecture.

All or a portion of the exemplary embodiments of FIGS. 1-5 can be conveniently implemented using one or more conventional general purpose computer systems, microprocessors, digital signal processors, micro-controllers, and the like, programmed according to the teachings of the embodiments of the present invention (e.g., using the computer system of FIG. 6), as can be appreciated by those skilled in the computer and software arts. Appropriate software can be readily prepared by programmers of ordinary skill based on the teachings of the present disclosure, as can be appreciated by those skilled in the software art. Further, the exemplary embodiments of FIGS. 1-5 can be implemented on the World Wide Web (e.g., using the computer system of FIG. 6). In addition, the exemplary embodiments of FIGS. 1-5 can be implemented by the preparation of application-specific integrated circuits or by interconnecting an appropriate network of conventional component circuits, as can be appreciated by those skilled in the electrical art(s).

FIG. 6 illustrates a computer system 600 upon which the exemplary embodiments (e.g., the devices and subsystems of the exemplary embodiments of FIGS. 1-5) can be implemented. The various embodiments can be implemented on a single such computer system, or a collection of multiple such computer systems. The computer system 600 can include a bus 601 or other communication mechanism for communicating information, and a processor 603 coupled to the bus 601 for processing the information. The computer system 600 also can include a main memory 605, such as a random access memory (RAM), other dynamic storage device (e.g., dynamic RAM (DRAM), static RAM (SRAM), synchronous DRAM (SDRAM)), etc., coupled to the bus 601 for storing information and instructions to be executed by the processor 603.

In addition, the main memory 605 also can be used for storing temporary variables or other intermediate information during the execution of instructions by the processor 603. The computer system 600 further can include a ROM 607 or other static storage device (e.g., programmable ROM (PROM), erasable PROM (EPROM), electrically erasable PROM (EEPROM), etc.) coupled to the bus 601 for storing static information and instructions.

The computer system 600 also can include a disk controller 609 coupled to the bus 601 to control one or more storage devices for storing information and instructions, such as a magnetic hard disk 611, and a removable media drive 613 (e.g., floppy disk drive, read-only compact disc drive, read/write compact disc drive, compact disc jukebox, tape drive, and removable magneto-optical drive). The storage devices can be added to the computer system 600 using an appropriate device interface (e.g., small computer system interface (SCSI), integrated device electronics (IDE), enhanced-IDE (E-IDE), direct memory access (DMA), or ultra-DMA).

The computer system 600 also can include special purpose logic devices 615, such as application specific integrated circuits (ASICs), full custom chips, configurable logic devices, e.g., simple programmable logic devices (SPLDs), complex programmable logic devices (CPLDs), field programmable gate arrays (FPGAs), and the like, for performing special processing functions, such as signal processing, image processing, speech processing, voice recognition, communications functions, statistical functions, spectral analysis functions, etc.

The computer system 600 also can include a display controller 617 coupled to the bus 601 to control a display 619, such as a cathode ray tube (CRT), liquid crystal display (LCD), active matrix display, plasma display, touch display, television display, etc., for displaying or conveying information to a computer user. The computer system can include input devices, such as a keyboard 621 including alphanumeric and other keys and a pointing device 623, for interacting with a computer user and providing information to the processor 603. The pointing device 623 can include, for example, a mouse, a trackball, a pointing stick, etc. or voice recognition processor, etc., for communicating direction information and command selections to the processor 603 and for controlling cursor movement on the display 619. In addition, a printer can provide printed listings of the data structures/information of the exemplary embodiments of FIGS. 1-5 or any other data stored and/or generated by the computer system 600.

The computer system 600 can perform all or a portion of the processing steps of the invention in response to the processor 603 executing one or more sequences of one or more instructions contained in a memory, such as the main memory 605. Such instructions can be read into the main memory 605 from another computer readable medium, such as the hard disk 611 or the removable media drive 613. Execution of the arrangement of instructions contained in the main memory 605 causes the processor 603 to perform the process steps described herein. One or more processors in a multi-processing arrangement also can be employed to execute the sequences of instructions contained in the main memory 605. In alternative embodiments, hard-wired circuitry can be used in place of or in combination with software instructions. Thus, embodiments are not limited to any specific combination of hardware circuitry and/or software.

Stored on any one or on a combination of computer readable media, the embodiments of the present invention can include software for controlling the computer system 600, for driving a device or devices for implementing the invention, and for enabling the computer system 600 to interact with a human user (e.g., users of the exemplary embodiments of FIGS. 1-5, etc.). Such software can include, but is not limited to, device drivers, firmware, operating systems, development tools, applications software, etc. Such computer readable media further can include the computer program product of an embodiment of the present invention for performing all or a portion (if processing is distributed) of the processing performed in implementing the invention. Computer code devices of the embodiments of the present invention can include any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the embodiments of the present invention can be distributed for better performance, reliability, and/or cost.

The computer system 600 also can include a communication interface 625 coupled to the bus 601. The communication interface 625 can provide a two-way data communication coupling to a network link 627 that is connected to, for example, a LAN 629, or to another communications network 633 (e.g., a wide area network (WAN), a global packet data communication network, such as the Internet, etc.). For example, the communication interface 625 can include a digital subscriber line (DSL) card or modem, an integrated services digital network (ISDN) card, a cable modem, a telephone modem, etc., to provide a data communication connection to a corresponding type of telephone line. As another example, the communication interface 625 can include a local area network (LAN) card (e.g., for Ethernet™, an Asynchronous Transfer Model (ATM) network, etc.), etc., to provide a data communication connection to a compatible LAN. Wireless links also can be implemented. In any such implementation, the communication interface 625 can send and receive electrical, electromagnetic, or optical signals that carry digital data streams representing various types of information. Further, the communication interface 625 can include peripheral interface devices, such as a Universal Serial Bus (USB) interface, a PCMCIA (Personal Computer Memory Card International Association) interface, etc.

The network link 627 typically can provide data communication through one or more networks to other data devices. For example, the network link 627 can provide a connection through the LAN 629 to a host computer 631, which has connectivity to the network 633 or to data equipment operated by a service provider. The LAN 629 and the network 633 both can employ electrical, electromagnetic, or optical signals to convey information and instructions. The signals through the various networks and the signals on the network link 627 and through the communication interface 625, which communicate digital data with computer system 600, are exemplary forms of carrier waves bearing the information and instructions.

The computer system 600 can send messages and receive data, including program code, through the network 629 and/or 633, the network link 627, and the communication interface 625. In the Internet example, a server can transmit requested code belonging to an application program for implementing an embodiment of the present invention through the network 633, the LAN 629 and the communication interface 625. The processor 603 can execute the transmitted code while being received and/or store the code in the storage devices 611 or 613, or other non-volatile storage for later execution. In this manner, computer system 600 can obtain application code in the form of a carrier wave. With the system of FIG. 6, the embodiments of the present invention can be implemented on the Internet as a Web Server 600 performing one or more of the processes according to the embodiments of the present invention for one or more computers coupled to the Web server 600 through the network 633 coupled to the network link 627.

The term computer readable medium as used herein can refer to any medium that participates in providing instructions to the processor 603 for execution. Such a medium can take many forms, including but not limited to, non-volatile media, volatile media, transmission media, etc. Non-volatile media can include, for example, optical or magnetic disks, magneto-optical disks, etc., such as the hard disk 611 or the removable media drive 613. Volatile media can include dynamic memory, etc., such as the main memory 605. Transmission media can include coaxial cables, copper wire and fiber optics, including the wires that make up the bus 601. Transmission media also can take the form of acoustic, optical, or electromagnetic waves, such as those generated during radio frequency (RF) and infrared (IR) data communications.

As stated above, the computer system 600 can include at least one computer readable medium or memory for holding instructions programmed according to the teachings of the invention and for containing data structures, tables, records, or other data described herein. Common forms of computer-readable media can include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the embodiments of the present invention can initially be borne on a magnetic disk of a remote computer connected to either of the networks 629 and 633. In such a scenario, the remote computer can load the instructions into main memory and send the instructions, for example, over a telephone line using a modem. A modem of a local computer system can receive the data on the telephone line and use an infrared transmitter to convert the data to an infrared signal and transmit the infrared signal to a portable computing device, such as a PDA, a laptop, an Internet appliance, etc. An infrared detector on the portable computing device can receive the information and instructions borne by the infrared signal and place the data on a bus. The bus can convey the data to main memory, from which a processor retrieves and executes the instructions. The instructions received by main memory can optionally be stored on storage device either before or after execution by processor.

Although the exemplary embodiments of FIGS. 1-5 are described in terms of determining properties of a beverage, such as wine, beer, soda, and the like, the exemplary embodiments can be employed for determining properties of other items, such as other consumables, and the like, as can be appreciated by those skilled in the relevant art(s).

While the present invention have been described in connection with a number of exemplary embodiments and implementations, the present invention is not so limited but rather covers various modifications and equivalent arrangements, which fall within the purview of the appended claims.

What is claimed is:

1. A computer-implemented method for aiding a consumer in choosing a beverage based upon personal preferences of the consumer, comprising:
obtaining spectral information of an inventory of beverages;
obtaining spectral information of a sample of a beverage; and
comparing the spectral information of the sample with that of the inventory to determine a beverage from the inventory that is similar to the sample,
wherein the spectral information for at least one of the inventory and the sample is obtained in a non-destructive manner.

2. The method of claim 1, further comprising:
displaying the results of the comparing step to a consumer, wherein the sample corresponds to a beverage preferred by the consumer.

3. The method of claim 1, wherein the spectral information includes at least one of visible, infrared, and near infrared spectral information.

4. The method of claim 1, wherein the comparing step includes performing statistical analysis on the spectral information for at least one of the inventory and the sample.

5. The method of claim 2, wherein the displaying step includes displaying a list of beverages form the inventory to the consumer that are similar to the beverage preferred by the consumer.

6. The method of claim 2, further comprising:
providing the consumer with at least one of sale information and stocking information for a beverage in the displayed results.

7. The method of claim 2, further comprising:
inputting from the consumer search criteria to narrow the displayed results.

8. The method of claim 7, wherein the search criteria includes at least one of price information and beverage type.

9. The method of claim 1, further comprising categorizing the sample into a category of the inventory.

10. A system for aiding a consumer in choosing a beverage based upon personal preferences of the consumer, comprising:
means for obtaining spectral information of an inventory of beverages;
means for obtaining spectral information of a sample of a beverage; and
means for comparing the spectral information of the sample with that of the inventory to determine a beverage from the inventory that is similar to the sample,
wherein the spectral information for at least one of the inventory and the sample is obtained in a non-destructive manner.

11. The system of claim 10, further comprising:
means for displaying the results of the comparing step to a consumer, wherein the sample corresponds to a beverage preferred by the consumer.

12. The system of claim 10, wherein the spectral information includes at least one of visible, infrared, and near infrared spectral information.

13. The system of claim 10, wherein the means for comparing includes means for performing statistical analysis on the spectral information for at least one of the inventory and the sample.

14. The system of claim 11, wherein the means for displaying includes means for displaying a list of beverages form the inventory to the consumer that are similar to the beverage preferred by the consumer.

15. The system of claim 11, further comprising:
means for providing the consumer with at least one of sale information and stocking information for a beverage in the displayed results.

16. The system of claim 11, further comprising:
means for inputting from the consumer search criteria to narrow the displayed results.

17. The system of claim 16, wherein the search criteria includes at least one of price information and beverage type.

18. The system of claim 10, further comprising means for categorizing the sample into a category of the inventory.

19. The system of claim 10, wherein the means for obtaining the spectral information for the inventory, the means for obtaining the spectral information of the sample, and the means for comparing the spectral information comprise devices of a computer system.

20. The system of claim 10, wherein the means for obtaining the spectral information for the inventory, the means for obtaining the spectral information of the sample, and the means for comparing the spectral information comprise computer-readable instructions stored on a computer readable medium.
